(19) United States
(12) Patent Application Publication
(10) Pub. No.: US 2013/0163172 A1
(43) Pub. Date: Jun. 27, 2013

(54) MOUNTING APPARATUS FOR DATA STORAGE DEVICE

(71) Applicants: YUN-LUNG CHEN, Tu-Cheng (TW); LIANG-CHIN WANG, Tu-Cheng (TW); YU-MING XIAO, Wuhan City (CN); ZAN LI, Wuhan City (CN); ZHONG-QI YU, Wuhan City (CN)

(72) Inventors: YUN-LUNG CHEN, Tu-Cheng (TW); LIANG-CHIN WANG, Tu-Cheng (TW); YU-MING XIAO, Wuhan City (CN); ZAN LI, Wuhan City (CN); ZHONG-QI YU, Wuhan City (CN)

(73) Assignees: HON HAI PRECISION INDUSTRY CO., LTD., Tu-Cheng (TW); HONG FU JIN PRECISION INDUSTRY (WuHAN) CO., LTD., Wuhan City (CN)

(21) Appl. No.: 13/598,852

(22) Filed: Aug. 30, 2012

(30) Foreign Application Priority Data
Dec. 22, 2011 (CN) 201110434879.7

(51) Int. Cl. G06F 1/16

(52) U.S. Cl. 361/679.31

(57) ABSTRACT

A mounting apparatus includes a mounting member and a cage for securing a data storage device. The cage includes a first side plate, an installation piece, and a blocking block extending from the first side plate. The mounting member includes a mounting piece, a positioning piece extending from the mounting piece, and a resisting piece connected to the mounting piece. The first side plate defines a cutout. The mounting piece defines a blocking hole. The positioning piece is engaged in the cutout, and the blocking block is engaged in the blocking hole to prevent the mounting member from moving along a direction substantially parallel to the first side plate. The mounting member is located between the first side plate and the installation piece to prevent the mounting member from moving along a direction substantially perpendicular to the first side plate. The resisting piece abuts against the first side plate.

### BACKGROUND

1. Technical Field

The present disclosure relates to mounting apparatuses, and particularly to a mounting apparatus for data storage devices.

2. Description of Related Art

A mounting apparatus for a data storage device includes a cage and a latch. The cage receives the data storage device therein. The latch prevents the data storage device from moving in the cage. However, the latch is secured to a side of the cage by screwing or riveting, which is laborious and time consuming. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting apparatus and a data storage device.

FIG. 2 is the same as FIG. 1 but viewed from a different aspect.

FIG. 3 is an assembled, isometric view of the mounting apparatus and the data storage device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

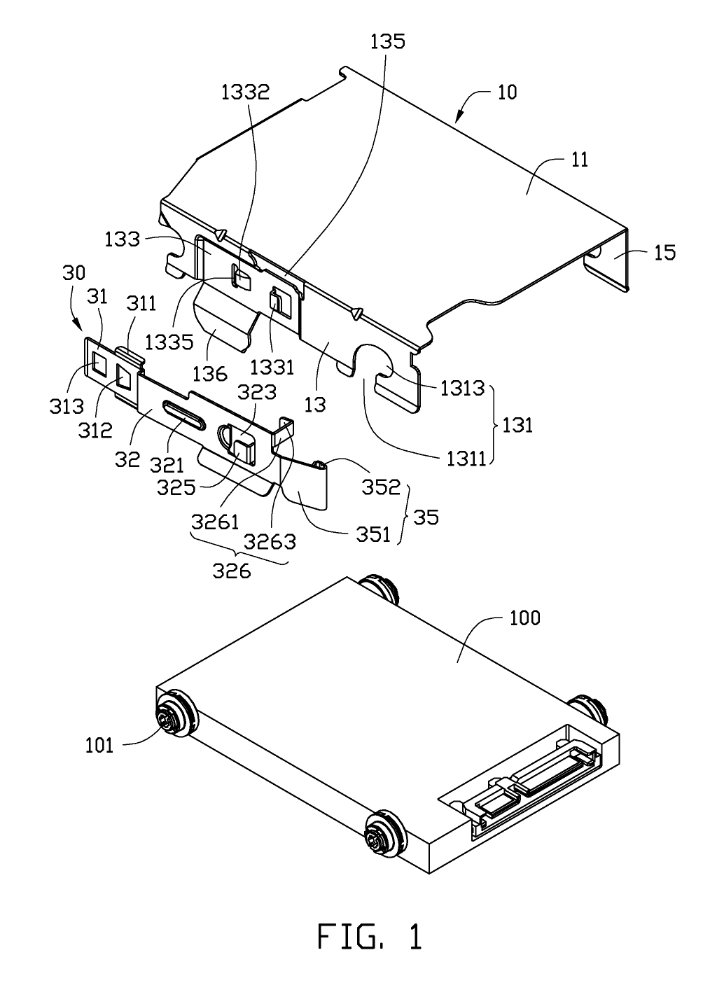

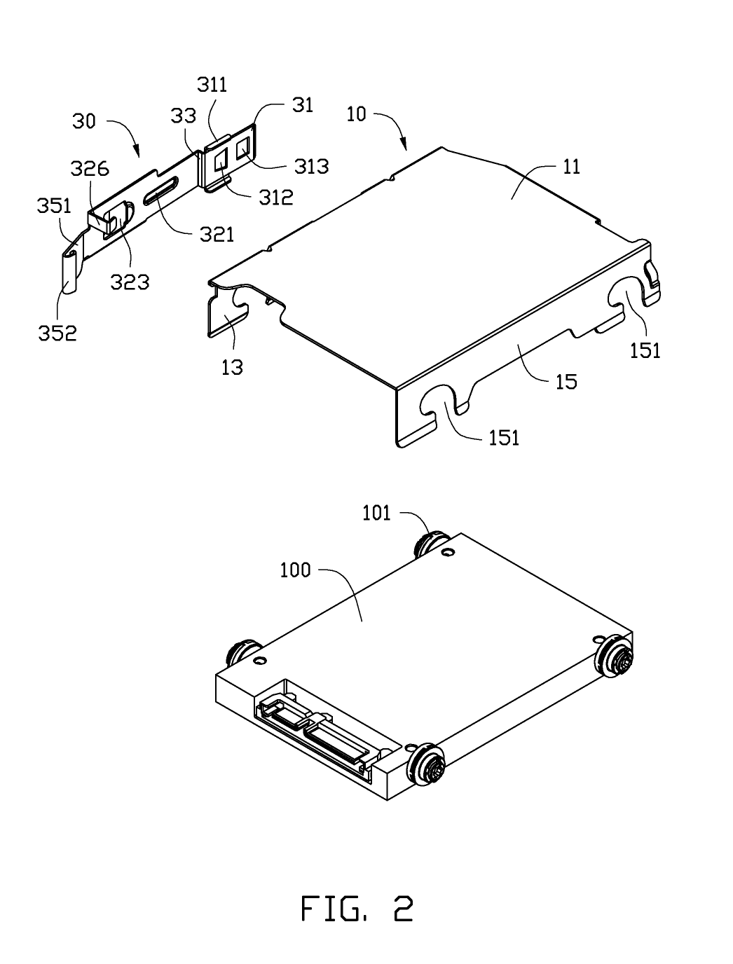

Referring to FIG. 1 and FIG. 2, a mounting apparatus in accordance with an embodiment is shown. The mounting apparatus includes a cage 10 and a mounting member 30.

The cage 10 includes a top plate 11, a first side plate 13, and a second side plate 15. In one embodiment, the first side plate 13 is substantially parallel to the second side plate 15, and the top plate 11 is substantially perpendicular to the first side plate 13 and the second side plate 15. The first side plate 13 defines two first installation slots 131. Each of the two first installation slots 131 includes an inserting end 1311 and a latching end 1313. A width of the inserting end 1311 is greater than a width of the latching end 1313. The first side plate 13 includes a recess portion 133, an installation piece 1331, and a blocking block 1335 extending from the recess portion 133. The installation piece 1331 extends away from the blocking block 1335 and is substantially parallel to the first side plate 13. The blocking block 1335 includes a curved outer surface 1332 extending away from the installation piece 1331 from the recess portion 133. The first side plate 13 defines a cutout 135 extending to the top plate 11 and a top edge of the recess portion 133. A blocking piece 136 extends from a bottom edge of the first side plate 13. The second side plate 15 defines two second installation slots 151 corresponding to the two first installation slots 131.

The mounting member 30 includes a mounting piece 31, a flange 33 (shown as in FIG. 2), and a resisting piece 32. The mounting piece 31 and the resisting piece 32 extend away from each other from two opposite edges of the flange 33, respectively. In one embodiment, the flange 33 is substantially perpendicular to the mounting piece 31. An acute angle is defined between the resisting piece 32 and the flange 33. Two positioning tabs 311 extend from two opposite edges of the mounting piece 31. In one embodiment, the two positioning tabs 311 are substantially perpendicular to the mounting piece 31. The mounting piece 31 defines a limiting hole 312 and a blocking hole 313. A protrusion 321 protrudes outwardly from the resisting piece 32 to reinforce the resisting piece 32. The resisting piece 32 defines a latching hole 323. A resilient piece 325 extends from an edge of the latching hole 323. In one embodiment, the resilient piece 325 is substantially perpendicular to the resisting piece 32. An operation portion 35 extends obliquely away from the flange 33 from a side edge of the resisting piece 32. The operation portion 35 includes an operation piece 351 and a bending flange 352 extending from the operation piece 351. The operation piece 351 is operable to elastically deform the resisting piece 32. The bending flange 352 prevents the operation piece 351 from damaging a finger of a user. A limiting portion 326 extends from the side edge of the resisting piece 32. The limiting portion 326 includes a connecting piece 3261 and a limiting piece 3263. The connecting piece 3261 is connected and substantially perpendicular to the resisting piece 32. The limiting piece 3263 extends from the connecting piece 3261 and is substantially parallel to the resisting piece 32.

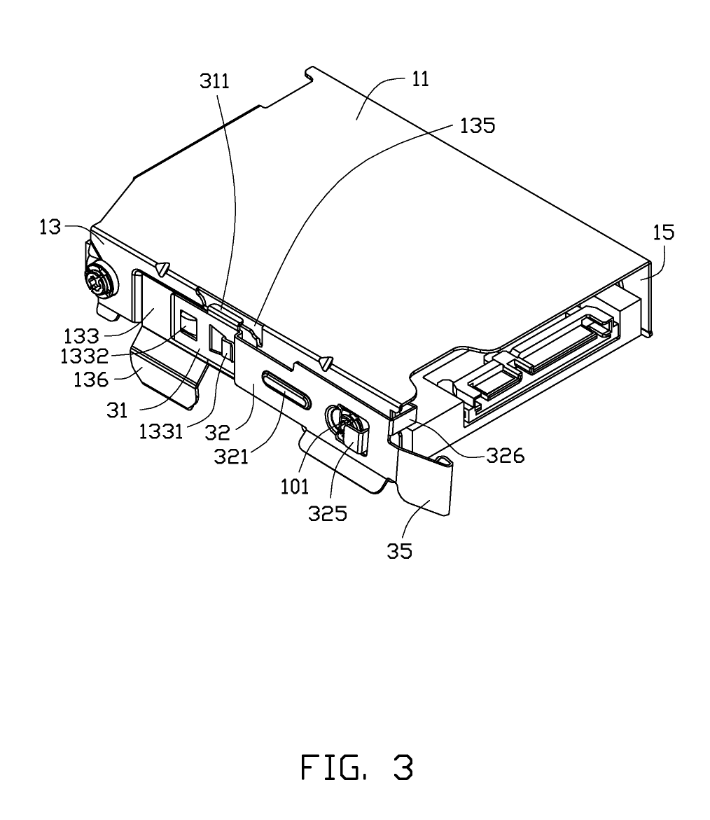

FIG. 3 shows the assembly of the mounting apparatus of an embodiment. The mounting member 30 is moved to be adjacent to the first side plate 13, the mounting piece 31 is adjacent to the recess portion 133, and the limiting hole 312 is aligned with the installation piece 1331. The mounting member 30 is moved to abut the first side plate 13. The installation piece 1331 extends out of the mounting piece 31 through the limiting hole 312. A first of the two positioning tabs 311 is inserted into the cutout 135. The mounting member 30 is moved towards the blocking block 1335. The mounting piece 31 is elastically deformed by the blocking block 1335. The resisting piece 32 is elastically deformed by the first side plate 13. The mounting member 30 is further moved until the mounting piece 31 is moved over the curved outer surface 1332, and the blocking block 1335 is aligned with the blocking hole 313. The mounting piece 31 restores to be received in the recess portion 133. The flange 33 abuts a side surface of the recess portion 133. The blocking block 1335 is engaged in the blocking hole 313, and the resisting piece 32 exerts elastic force to press against the first side plate 13 to prevent the mounting member 30 from moving along a first direction substantially parallel to the first side plate 13. The installation piece 1331 abuts an outer surface of the mounting piece 31 to prevent the mounting member 30 from moving along a second direction substantially perpendicular to the first side plate 13. The limiting portion 326 extends into the cage 10. The operation portion 35 extends out of the first side plate 13 towards the second side plate 15. A second of the two positioning tabs 311 abuts the blocking piece 136.

The mounting apparatus can be used for mounting a data storage device 100. The data storage device 100 includes two installation members 101 in each of two opposite sides. In one embodiment, the data storage device 100 is a hard disk drive, and each installation member is a screw.

In assembly of the data storage device 100, the data storage device 100 is positioned in the cage 10, and the installation member 101 is aligned with the first installation slot 131 and the second installation slot 151. The data storage device 100 is moved towards the top plate 11. The installation members 101 elastically deform the resisting piece 32. The installation members 101 is slid along the first installation slot 131 and the second installation slot 151, until the installation members 101 extend out of the latching hole 323 and are engaged in the latching end 1313 and the second installation slot 151. The resisting piece 32 restores to press against the installation members 101 to prevent the data storage device 100 from moving along a direction substantially perpendicular to the first side plate 13.

The cage 10 can be secured to a chassis (not shown). In one embodiment, the mounting member 30 is made of metal. The resilient member 325 abuts against the installation members 101 to prevent electromagnetic interference.

In disassembly, the operation piece 351 is pushed away from the first side plate 13, and the installation members 101 disengage from the resilient piece 325 and the resisting piece 32. Thus, the data storage device 100 can be removed from the cage 10.

The limiting piece 3263 abuts against an inner surface of the first side plate 13 when the operation portion 35 is moved away from the first side plate 13 to prevent the operation piece 351 from deforming or damage.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A mounting apparatus for a data storage device, the mounting apparatus comprising:
a cage securing the data storage device and comprising a first side plate, an installation piece, and a blocking block extending from the first side plate; and
a mounting member comprising a mounting piece, a positioning piece extending from the mounting piece, and a resisting piece connected to the mounting piece;
wherein the first side plate defines a cutout; the mounting piece defines a blocking hole; the positioning piece is engaged in the cutout, and the blocking block is engaged in the blocking hole to prevent the mounting member from moving along a first direction substantially parallel to the first side plate; the mounting member is located between the first side plate and the installation piece to prevent the mounting member from moving along a second direction substantially perpendicular to the first side plate; and the resisting piece abuts against the first side plate.

2. The mounting apparatus of claim 1, wherein the blocking block extends away from the installation piece from the first side plate.

3. The mounting apparatus of claim 1, wherein the blocking block comprises a curved outer surface, and the curved outer surface extends obliquely away from the blocking block.

4. The mounting apparatus of claim 1, wherein the mounting member further comprises a connecting piece connected to the mounting piece; the mounting piece and the resisting piece extend from two opposite edges of the connecting piece; the first side plate defines a recess portion, the blocking block and the installation piece extend from the recess portion, and the mounting piece is received in the recess portion.

5. The mounting apparatus of claim 4, wherein the connecting piece is substantially perpendicular to the mounting piece, and an obtuse angle is defined between the resisting piece and the connecting piece.

6. The mounting apparatus of claim 4, wherein the resisting piece defines a latching hole, the mounting member further comprises a resilient piece bending from an edge of the latching hole, and the resilient piece is elastically deformable.

7. The mounting apparatus of claim 6, wherein the resilient piece is substantially parallel to the resisting piece.

8. The mounting apparatus of claim 4, wherein the cage further comprises a second side plate, and the second side plate is substantially parallel to the first side plate; the mounting member further comprises an operation portion extending from the resisting piece; the operation portion is operable to elastically deform the resisting piece; and the operation portion extends out of the first side plate towards the second side plate.

9. The mounting apparatus of claim 8, wherein the mounting member further comprises a limiting portion extending from the resisting piece; the limiting portion comprises a limiting piece substantially parallel to the resisting piece; the limiting piece is located between the first side plate and the second side plate; and the limiting piece abuts against the first side plate when the resisting piece is elastically deformed.

10. The mounting apparatus of claim 8, wherein the operation portion comprises an operation piece and a bending flange, and an obtuse angle is defined between the resisting piece and the operation piece.

11. A mounting apparatus for data storage device, the mounting apparatus comprising:
a cage securing the data storage device and comprising a first side plate, a second side plate opposite to the first side plate, an installation piece, and a blocking block extending from the first side plate; and
a mounting member comprising a mounting piece, a positioning piece extending from the mounting piece, a resisting piece connected to the mounting piece, a limiting portion, and an operation portion extending from the resisting piece;
wherein the first side plate defines a cutout; the mounting piece defines a blocking hole; the positioning piece is engaged in the cutout, and the blocking block is engaged in the blocking hole to prevent the mounting member from moving along a first direction substantially parallel to the first side plate; the mounting member is located between the first side plate and the installation piece to prevent the mounting member from moving along a second direction substantially perpendicular to the first side plate; the resisting piece abuts against the first side plate; the operation portion is operable to elastically deform the resisting piece away from the first side plate; the limiting portion comprises a limiting piece, and the limiting piece abuts against the first side plate when the resisting piece is elastically deformed.

12. The mounting apparatus of claim 11, wherein the blocking block extends away from the installation piece from the first side plate.

13. The mounting apparatus of claim 11, wherein the blocking block comprises a curved outer surface, and the curved outer surface extends obliquely away from the blocking block.

14. The mounting apparatus of claim 11, wherein the mounting member further comprises a connecting piece connected to the mounting piece; the mounting piece and the resisting piece extend from two opposite edges of the connecting piece; the first side plate defines a recess portion, the blocking block and the installation piece extend from the recess portion, and the mounting piece is received in the recess portion.

15. The mounting apparatus of claim 14, wherein the connecting piece is substantially perpendicular to the mounting piece, and an obtuse angle is defined between the resisting piece and the connecting piece.

16. The mounting apparatus of claim 14, wherein the resisting piece defines a latching hole, the mounting member further comprises a resilient piece bending from an edge of the latching hole, and the resilient piece is elastically deformable.

17. The mounting apparatus of claim 16, wherein the resilient piece is substantially parallel to the resisting piece.

18. The mounting apparatus of claim 11, wherein the second side plate is substantially parallel to the first side plate; and the operation portion extends out of the first side plate towards the second side plate.

19. The mounting apparatus of claim 11, wherein the limiting piece is substantially parallel to the resisting piece.

20. The mounting apparatus of claim 11, wherein the operation portion comprises an operation piece and a bending flange, and an obtuse angle is defined between the resisting piece and the operation piece.
